(19) United States
(12) Patent Application Publication
(10) Pub. No.: US 2004/0076314 A1
(43) Pub. Date: Apr. 22, 2004

(54) Fingerprint sensor devices with finger placement guidance

(76) Inventor: David Cheng, Binfield (GB)

Correspondence Address: LUMEN INTELLECTUAL PROPERTY SERVICES, INC., 2345 YALE STREET, 2ND FLOOR, PALO ALTO, CA, 94306, US

(21) Appl. No.: 10/278,747

(22) Filed: Oct. 22, 2002

(51) Int. Cl. G06K 9/00

(52) U.S. Cl. 382/126

(57) ABSTRACT

An apparatus and method is provided that includes a fingerprint sensor and a guiding means. The sensing site of the fingerprint sensor makes a relative and obtuse angle with a guiding plane of the guiding means. The relative position of the guiding means with the fingerprint sensor allows for a more natural and ergonomically advantageous manner in obtaining a fingerprint. The task of reproducing a fingerprint now comes down to a pointing task of the fingertip to a guiding means. In addition, the relative position of the fingerprint sensor with the guiding means increases the reproducibility and reliability of fingerprint biometrics and authentication. Furthermore, the guiding means can be used as guidance but also as a sensor or actuator to initiate a process upon positive verification of the obtained fingerprint or to trigger the process of obtaining the fingerprint itself.

### FIELD OF THE INVENTION

The present invention relates generally to fingerprint sensors. More particularly, the present invention relates to the placement and positioning of a fingerprint sensor in combination with a guiding means.

### BACKGROUND

Fingerprint sensors are capable of scanning fingerprints and are commonly used in a variety of different application areas that are concerned with the identification, registration, verification and authentication of an individual. A fingerprint has a characteristic anatomical pattern that is unique to the individual bearing it. Although fingerprint patterns vary widely from type to type, each fingerprint has a small central area around which the remainder of the pattern is distributed. This central area is the core of the fingerprint and is located at the palm-site of the distal phalange of a finger. More specifically, this core is more or less opposite to the point that the fingernail emerges from the cuticle. In principle, a fingerprint could be obtained from different locations of a finger. However, the fingertip alone contains insufficient image data for a high-quality fingerprint. The ridges in the fingertip area are mostly parallel lines, with few distinct minutiae from which to construct an identification template.

In order to obtain a certain degree of reliability and reproducibility in obtaining a fingerprint in these different application areas, it is important to obtain a fingerprint from more or less the same part of the finger. However, several problems exist with the current fingerprint devices that cause various kinds of inaccuracies in obtaining a fingerprint jeopardizing the reliability and reproducibility of fingerprint biometrics.

For instance, it is difficult to control the actual placement of a finger on a fingerprint sensor with the existing fingerprint devices in terms of what part of the finger actually touches the fingerprint sensor. Most devices require a finger to be placed flat on the fingerprint device in order to scan at least a portion of the palm-site of the distal phalange of a finger. If a person is untrained in the process of taking a fingerprint, then that person is more likely to use his/her fingertip instead of the palm-site part of the distal phalange of a finger. This is not surprising, since the natural way of a finger to approach a fingerprint sensor that is positioned in a more or less horizontal or flat position, is to point with the fingertip of the finger to the fingerprint sensor. However, in case the fingerprint sensor is positioned in such a more or less horizontal or flat position, a skilled person in taking a fingerprint would flex his/her finger and/or hand to accommodate the position of the fingerprint sensor to ensure that the palm-site part of the distal phalange of a finger is touching the fingerprint sensor correctly. This does not only necessitate an awkward movement or position of the finger and/or hand, in some people the hand and/or fingers would also be anatomically constrained to flex the hand and/or finger correctly with respect to such a more or less horizontal positioned fingerprint sensor.

An additional problem is that it is difficult to control the firmness and/or rotation of the finger at the fingerprint sensor. A lighter touch by the finger at the fingerprint sensor could easily result in a different reading by the fingerprint sensor than a more solid touch by the finger at the fingerprint sensor. Furthermore, comparison software that compares two or more fingerprints has limited capability when dealing with variation between fingerprint samples.

In order to overcome some of the finger placement problems, some fingerprint devices include a guard around the fingerprint sensor to limit finger rotation and the approximate depth a finger could be placed with respect to the fingerprint sensor. However, the guards are not always effective in minimizing the finger rotation and accuracy of finger placement.

Accordingly, there is a need to develop new devices and methods that would overcome the problems that exist with the current devices in which fingerprints are obtained.

### SUMMARY OF THE INVENTION

The present invention provides an apparatus and method that overcomes the limitations and problems in prior fingerprint devices and systems that are used for obtaining a fingerprint of an individual. First, the present invention includes a fingerprint sensor. The sensing site of the fingerprint sensor is capable of receiving the palm-site of the distal phalange of a user's finger.

Second, the present invention includes a guiding means. The guiding means is positioned in proximity to the fingerprint sensor with the purpose to guide the fingertip of a user's finger toward the guiding means. Concurrently with this movement, the palm-site of the distal phalange of a user's finger is guided toward the sensing site of the fingerprint sensor.

The position and placement of the guiding means relative to the fingerprint sensor is important and needs to establish that when the fingertip touches the guiding means, the palm-site of the distal phalange touches the sensing site of the fingerprint sensor. The position of the fingerprint sensor and guiding means could be either on the same place or on different planes (also referred to as a first contact area and a second contact area or guiding plane). In general, the guiding means includes a guiding plane that makes a relative and obtuse angle with the fingerprint sensor. The relative and obtuse angle between the guiding plane and fingerprint sensor allows an individual to approach the sensing site of the fingerprint sensor in a natural way and biomechanically advantageous fashion by pointing the fingertip to a guiding means.

In one embodiment, the relative and obtuse angle of the fingerprint sensor with the guiding plane is substantially 140 degrees with a standard deviation of substantially +/−20 degrees. In another embodiment, where the guiding plane is projected from a tangent of a curved surface of the guiding means, the relative and obtuse angle is greater than or equal to substantially 90 degrees and less than substantially 180 degrees.

Furthermore, in one embodiment of the present invention, guiding means could be any type of object or element that is static to provide visual guidance to a person to place his/her fingertip on the guiding means. Guiding means could be a contact point or area. Guiding means could also be a visual representation.

In another embodiment of the present invention, guiding means includes a moving means. In addition to providing visual guidance, the idea is that when the fingertip touches and moves the moving means backwards (i.e. in direction of the fingerprint sensor), the palm site of the distal phalange touches the sensing site in a firm and correct manner. The moving means could include various different types of means that enable movement such as a switch, a rolling bar, a rolling ball or a rolling wheel. In other words, moving means could include a rolling means, a pushing means, a pulling means, a flipping means or a gliding means.

In yet another embodiment of the present invention, guiding means includes a sensor. The sensor could be a sensor that is activated by the touch of the fingertip and/or could be a sensor that is activated by a movement of the fingertip. The present invention could include a wide variety of sensors such as, but not limited to, a switch, a rolling bar, a rolling ball, a rolling wheel, a second fingerprint sensor that reads the minutiae of the fingertip, an optical sensor or a conductive element. The sensor could be associated with a predetermined function that could be executed by an execution means once the fingertip of the user's finger activates the sensor. In some cases or systems, it might be necessary or desired to first verify an individual's fingerprint before executing the predetermined function or action. Therefore, the present invention further includes a verifying means to verify the fingerprint obtained from the palm-site of the distal phalange by fingerprint sensor.

In view of that which is stated above, it is the objective of the present invention to provide a fingerprint sensor in combination with a guiding means located on a guiding plane whereby the fingerprint sensor and guiding plane make a relative and obtuse angle.

It is still another objective of the present invention to provide a fingerprint sensor in combination with a guiding means to ensure a more natural and ergonomical movement of an individual's finger when obtaining a fingerprint of the palm site of the distal phalange of an individual's finger once the fingertip of the same finger touches the guiding means.

It is still another objective of the present invention to position a fingerprint sensor and a guiding means in such a way to ensure a firm and correct placement of the palm site of the distal phalange of an individual's finger.

It is still another objective of the present invention to provide a guiding means to guide the fingertip and thereby the palm site of the distal phalange of an individual's finger to the sensing of a fingerprint sensor.

It is still another objective of the present invention to provide a guiding means with a moving means to enable that when the fingertip touches and moves the moving means backwards (i.e. in the direction of the fingerprint sensor), the palm site of the distal phalange touches the sensing site in a firm and correct manner.

It is still another objective of the present invention to provide a guiding means with a sensor that is activated by the touch of the fingertip and/or activated by a movement of the fingertip.

It is still another objective of the present invention to provide a sensor with a predetermined function or action that is executed once a fingerprint is successfully verified.

The present invention is advantageous over previous fingerprint devices, systems and methods since the orientation of the fingerprint sensor and the relative position of the guiding means and the fingerprint sensor allows for a more natural and ergonomically advantageous manner in obtaining a fingerprint. The task of reproducing a fingerprint now comes down to a pointing task of the fingertip to a guiding means. A person no longer has to worry about a correct placement of the central core at the fingerprint sensor since this would be achieved concurrently and in a more or less automatic fashion once the fingertip touches guiding means. In addition, the orientation of the fingerprint sensor and the relative position of the guiding means increase the reproducibility and reliability of fingerprint biometrics and authentication. Furthermore, the guiding means can be used as guidance but also as a sensor or actuator to initiate a process upon positive verification of the obtained fingerprint or to trigger the process of obtaining the fingerprint itself.

### BRIEF DESCRIPTION OF THE FIGURES

The objectives and advantages of the present invention will be understood by reading the following summary in conjunction with the drawings, in which:

FIG. 1 shows a fingerprint sensor and a guiding means according to the present invention;

FIG. 2 shows the relative and obtuse angle of the fingerprint sensor according to the present invention;

FIGS. 3-5 show additional examples of a fingerprint sensor and a guiding means according to the present invention;

FIG. 6 shows a fingerprint sensor and a guiding means in which the guiding means includes a moving means according to the present invention;

FIG. 7 shows a fingerprint sensor and a guiding means in which the guiding means includes a sensor according to the present invention; and

FIG. 8 shows a system according to the present invention.

### DETAILED DESCRIPTION OF THE INVENTION

Although the following detailed description contains many specifics for the purposes of illustration, anyone of ordinary skill in the art will readily appreciate that many variations and alterations to the following exemplary details are within the scope of the invention. Accordingly, the following preferred embodiment of the invention is set forth without any loss of generality to, and without imposing limitations upon, the claimed invention.

The present invention provides an apparatus and method for obtaining a fingerprint from an individual. The present invention is useful in a wide variety of applications such as in the identification, registration, verification and authentication of an individual. For the purpose of the present invention, obtaining a fingerprint is defined as obtaining a scan or image with a fingerprint sensor from an area around the central area at which the fingerprint pattern is distributed. This central area is the core of the fingerprint and is located at the palm-site part of the distal phalange of a finger. More specifically, this central area is more or less opposite the point that the fingernail emerges from the cuticle.

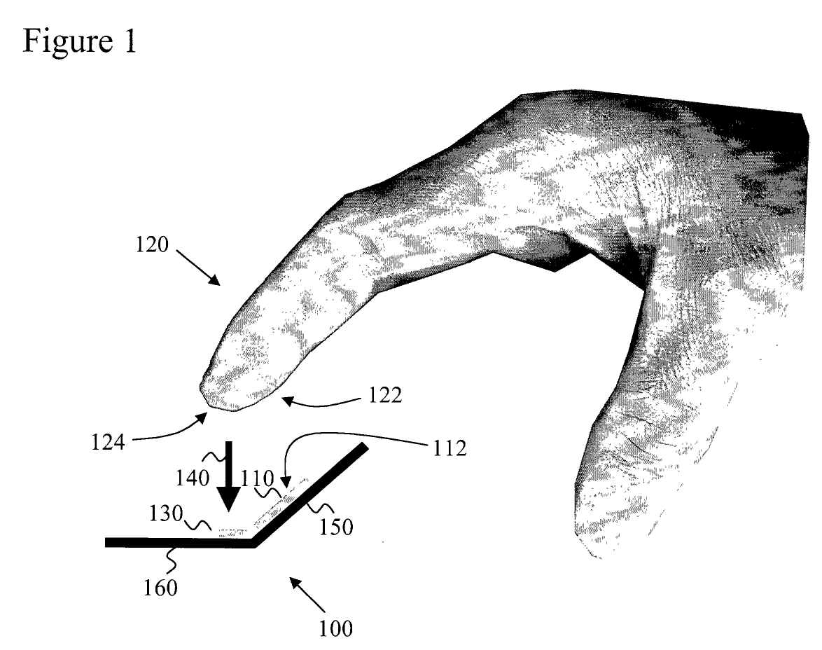

FIG. 1 shows an apparatus 100 with a fingerprint sensor 110. Fingerprint sensor 110 has a sensing site 112 that is capable of receiving the palm-site 122 of the distal phalange of finger 120 in order to obtain a fingerprint from finger 120. The size of the area from which a fingerprint is obtained is usually dependent on the size of the fingerprint sensor and/or the capabilities of the scanning and processing software. The present invention is not limited to the size of the fingerprint sensor as long as at least a portion around the central area at the palm-site of the distal phalange of a finger can be scanned or imaged as a fingerprint.

One of the key ideas of the present invention is that it allows an individual to approach fingerprint sensor 110 in a natural and ergonomical way by pointing fingertip 124 of finger 120 to a guiding means 130. Guiding means 130 is positioned in proximity to fingerprint sensor 110 to guide fingertip 124 toward 140 to guiding means 130. Associated with this movement 140 by finger 120 is that palm-site 122 of the distal phalange of finger 120 is guided or moved toward sensing site 112 of fingerprint sensor 110 in a natural and ergonomic fashion without imposing any awkward movement or position to the individual's hand and/or finger.

The position of guiding means 130 relative to fingerprint sensor 110 is important. This position should ensure a constant distance between fingerprint sensor 110 and guiding means 130 in order to achieve that palm-site 122 of distal phalange touches sensing site 112 of fingerprint sensor 110 when fingertip 124 touches guiding means 130. The task of reproducing a fingerprint now comes down to a pointing task of fingertip 124 to guiding means 130. A person no longer has to worry about a correct placement of the central core at the fingerprint sensor since this would be achieved concurrently and in a more or less automatic fashion once fingertip 124 touches guiding means 130. If the position of fingertip 124 at guiding means 130 is more or less the same, then the position of palm-site 122 of the distal phalange at fingerprint sensor 110 is more or less the same.

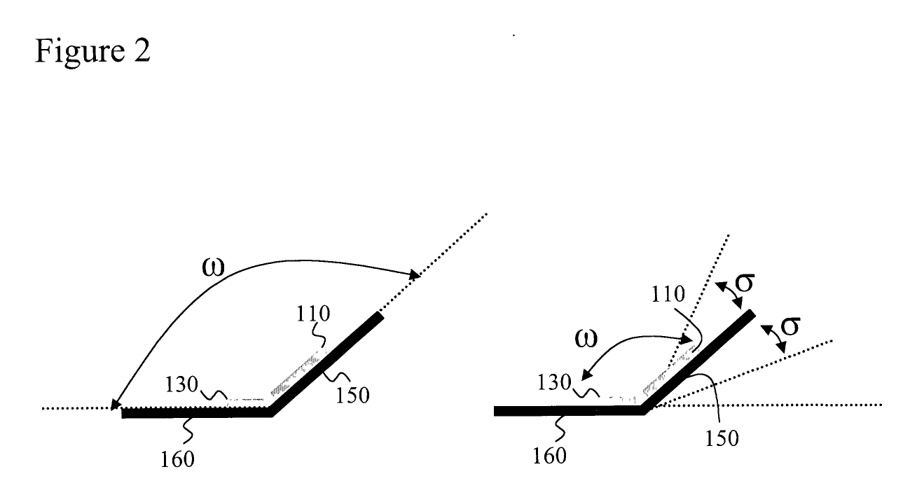

There are several different ways to establish the desired position between fingerprint sensor 110 and guiding means 130. Guiding means 130 could be positioned at the same plane as the plane at which fingerprint sensor 110 is positioned. Guiding means 130 could also be positioned at a different plane as the plane at which fingerprint sensor 110 is positioned. FIG. 1 shows an example in which the fingerprint sensor 110 and guiding means 130 are located on two different planes or surfaces, i.e. fingerprint sensor 110 is located on first surface 150 and guiding means 130 is located on second surface 160 which is also referred to as a guiding plane. Irrespective of the choice on where and how fingerprint sensor 110 and guiding means 130 are positioned or located on the apparatus or system, sensing site 112 of fingerprint sensor 110 and the plane associated with guiding means 130 will always make a relative and obtuse angle. FIG. 2 shows relative and obtuse angle ω of substantially 140 degrees which is considered to be the optimal angle enabling an individual to touch fingerprint sensor 110 in a more natural and biomechanically advantageous fashion. However, in some cases it might be preferred to have fingerprint sensor to be in a more upright position from angle ω, whereas in other cases it might be preferred to have fingerprint sensor to be in a downward position from angle ω. Therefore, in a preferred embodiment, obtuse angle ω is defined as substantially 140 degrees with a standard deviation σ of substantially +/−20 degrees.

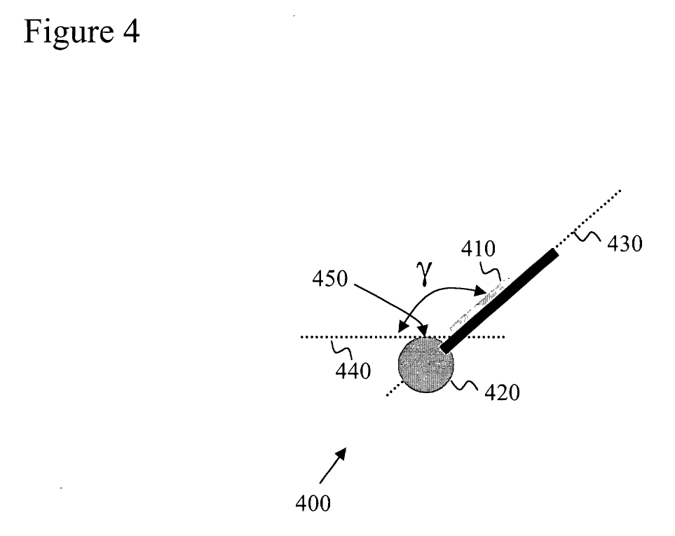

FIGS. 1-2 show second surface 160 in a horizontal position. However, second surface 160 is not limited to a horizontal position since second surface 160 could also be positioned at a vertical position as shown by second surface 310 in apparatus 300. However, as shown by apparatus 400 in FIG. 4, fingerprint sensor 410 and guiding means 420 could still be located on more or less the same plane or surface 430 (i.e. abstract or physical) as long as guiding means 420 extends above plane 430 to ensure that the palm-site of the distal phalange touches sensing site of fingerprint sensor 410 when the fingertip touches guiding means 420. For example, plane 440 that is based on the tangent of a curve of a potential contact point 450 of a fingertip on guiding means 420, makes an angle γ with fingerprint sensor 410. Preferably, angle γ is greater than or equal to substantially 90 degrees and less than substantially 180 degrees. A consideration that will decide the placement of fingerprint sensor and guiding means is whether the finger could generate enough pressure with the palm-site of the finger onto the fingerprint sensor to enable a firm enough touch to ensure a good fingerprint reading once the fingertip of that finger touches the guiding means. These considerations also take into account the location of the fingerprint device in relation to the person using the fingerprint device. For example, the fingerprint device could be located at desktop or elbow level, the fingerprint device could be located at eye or head level, or the fingerprint device could be approached from a lying down position of the user.

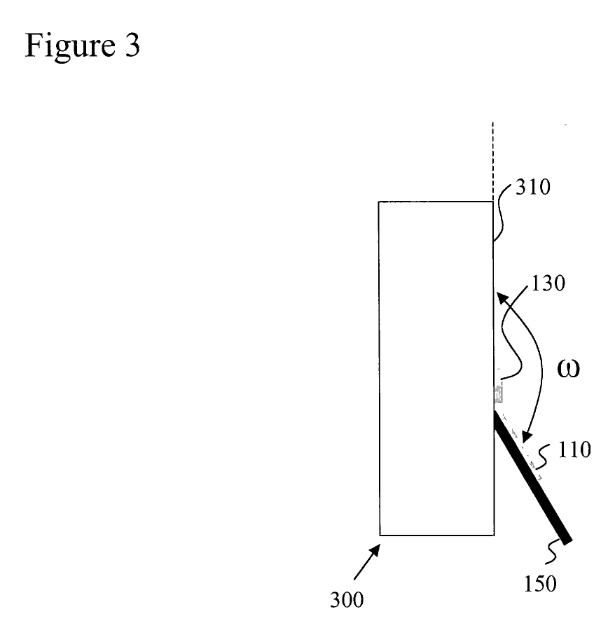

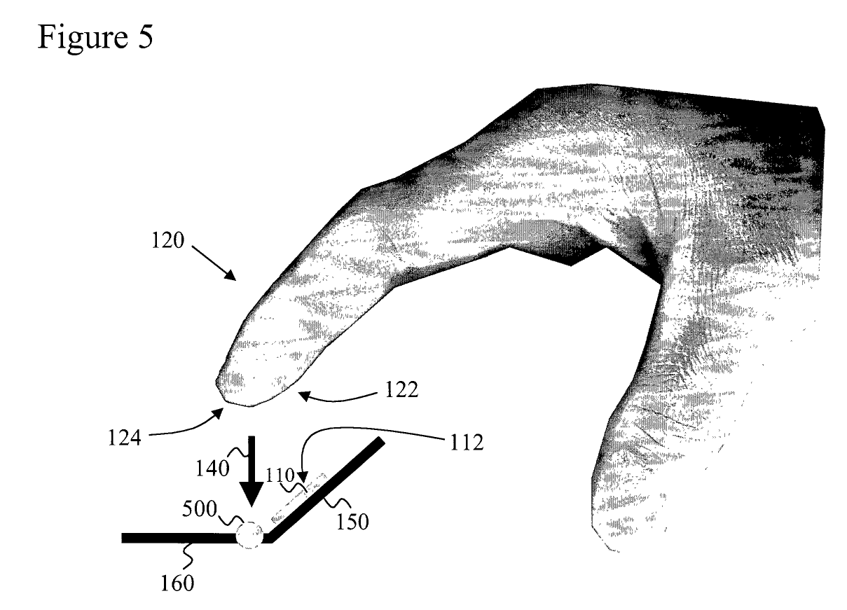

In one embodiment of the present invention, guiding means could be any type of object or element that is static. Here, guiding means provides visual guidance to a person to place his/her fingertip on the guiding means. Guiding means could be a contact point or area. Guiding means could also be a visual representation such as a colored shape or picture. As shown in FIGS. 1-3, guiding means could be a more or less flat element or object, or as shown in FIGS. 4-5, guiding means could be a round element or object 420, 500 respectively. However, as a person of average skill in the art to which the present invention pertains would readily appreciate, guiding means could take any type of shape or form as long as it does not jeopardize the objectives and advantages of the present invention. Also, the integration of guiding means in the apparatus is not limited to the present invention since the guiding means could be attached to the apparatus or integrated within the apparatus.

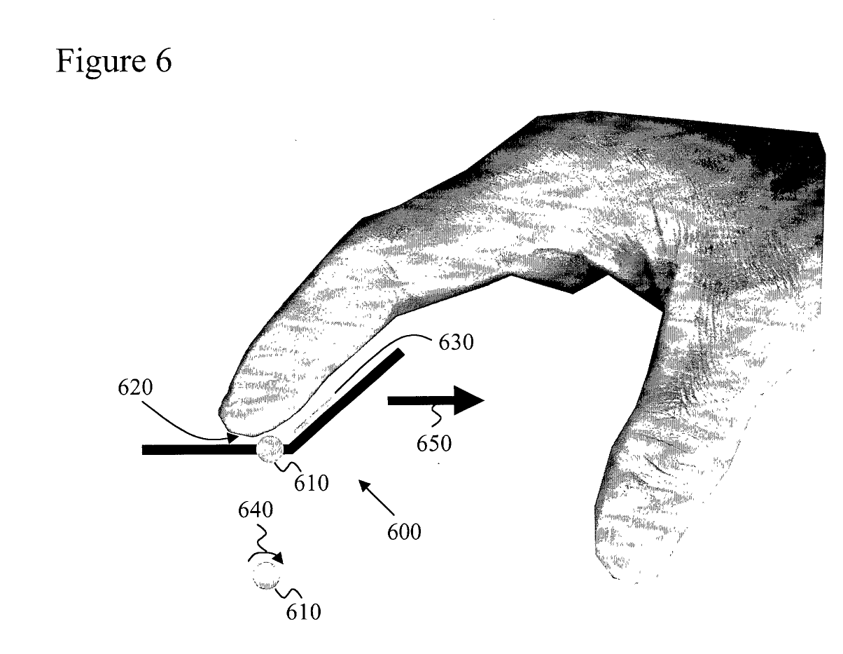

In another embodiment of the present invention, guiding means includes a moving means 610 as shown in apparatus 600 in FIG. 6. Here, in addition to providing visual guidance, the idea is that when fingertip 620 touches and moves moving means 610 backwards (i.e. in direction of fingerprint sensor 630), the palm site of the distal phalange touches the sensing site. In this way, a firm and correct placement of the central core of the palm site of the distal phalange at fingerprint sensor 630 is almost guaranteed since the palm-site moves backwards and onto fingerprint sensor 630. In the exemplary embodiment of FIG. 6, moving means 610 is a rolling ball and fingertip 620 rolls 640 rolling ball clockwise (as indicated in FIG. 6) to achieve finger movement in the direction indicated by arrow 650. Moving means 610 could be a rolling bar, a rolling ball, a rolling wheel or any type of moving element or object that allows for the desired backward motion of the finger to place the palm-site of the distal phalange at fingerprint sensor 630. The movement of moving means could be established by a rolling means as shown in FIG. 6 or by any other type of means that allows movement, such as, but not limited to, a pushing means, a pulling means, a flipping means or a gliding means.

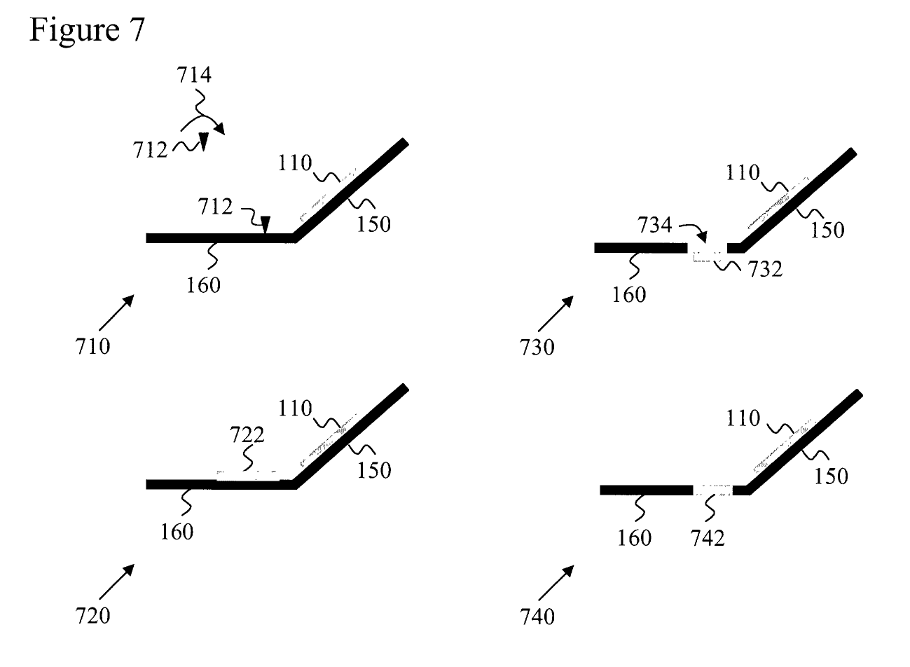

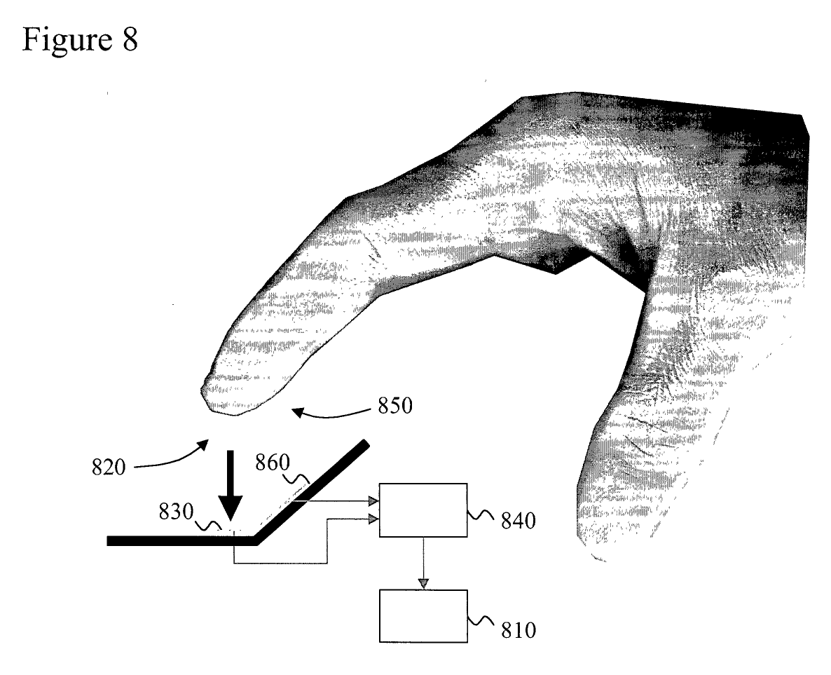

In yet another embodiment of the present invention, the guiding means could include a sensor. The fingertip would then activate this sensor. The sensor could be a sensor that is activated by the touch of the fingertip and/or could be a sensor that is activated by a movement of the fingertip. In this light, the present invention could include a wide variety of sensors such as, but not limited to, a switch, a rolling bar, a rolling ball, a rolling wheel, a second fingerprint sensor that reads the minutiae of the fingertip, an optical sensor or a conductive element. FIG. 7 shows some examples of how different sensors. For instance sensor 712 (e.g. a switch that can be pulled or pushed backwards 714), sensor 722 (e.g. a conductive element that can be touched or on which the fingertip has to make a backward motion 724 or a fingerprint sensor), sensor 732 (e.g. an optical sensor that can be touched at an optically transparent surface 734) or sensor 742 (e.g. an optical sensor or conductive element) could be integrated in or attached to apparatus 710, 720, 730 or 740 respectively. The sensor could be associated with a predetermined function or action such as opening a door, opening a computer file, entering a secured area or system, accessing classified information or sites, etc. As it is shown in FIG. 8, the predetermined function could be executed by an execution means 810 once the fingertip 820 activates the sensor 830. In some cases, it might be necessary or desired to first verify an individual's fingerprint before executing the predetermined function or action. Therefore, the present invention further includes a verifying means 840 to verify the fingerprint obtained from the palm-site 850 of the distal phalange by fingerprint sensor 860. The prior art teaches various kinds of verifying means that are suitable for the present invention. The predetermined function is then executed by the execution means 810 once the fingerprint is successfully verified by verifying means 840 assuming that the fingertip has activated sensor 830.

The present invention has now been described in accordance with several exemplary embodiments, which are intended to be illustrative in all aspects, rather than restrictive. Thus, the present invention is capable of many variations in detailed implementation, which may be derived from the description contained herein by a person of ordinary skill in the art. All such variations are considered to be within the scope and spirit of the present invention as defined by the following claims and their legal equivalents.

What is claimed is:

1. An apparatus for obtaining a fingerprint of a user's finger, comprising:
(a) a fingerprint sensor wherein the sensing site of said fingerprint sensor is capable of receiving the palm-site of the distal phalange of said user's finger; and
(b) a guiding means wherein said guiding means comprises a guiding plane wherein said guiding plane makes a relative and obtuse angle with said fingerprint sensor, and wherein said guiding means guides the fingertip of said user's finger toward said guiding means and therewith guiding said palm-site of said distal phalange of said user's finger toward said sensing site of said fingerprint sensor.

2. The apparatus as set forth in claim 1, wherein said relative and obtuse angle is substantially 140 degrees with a standard deviation of substantially +/−20 degrees.

3. The apparatus as set forth in claim 1, wherein said guiding plane is a tangent of a contact point of said fingertip at said guiding means.

4. The apparatus as set forth in claim 3, wherein said relative and obtuse angle is greater than or equal to substantially 90 degrees and less than substantially 180 degrees.

5. The apparatus as set forth in claim 1, wherein said position of said guiding means establishes that when said fingertip of said user's finger touches said guiding means, said palm-site of said distal phalange of said user's finger touches said sensing site of said fingerprint sensor.

6. The apparatus as set forth in claim 1, wherein said guiding means is positioned at the same plane as the plane at which said fingerprint sensor is positioned.

7. The apparatus as set forth in claim 1, wherein said guiding means is positioned at a different plane from the plane at which said fingerprint sensor is positioned.

8. The apparatus as set forth in claim 1, wherein said guiding means is positioned substantially near the bottom area of said fingerprint sensor.

9. The apparatus as set forth in claim 1, wherein said guiding means comprises a contact point or contact area for said fingertip.

10. The apparatus as set forth in claim 1, wherein said guiding means comprises a visual object.

11. The apparatus as set forth in claim 1, wherein said guiding means comprises a moving means.

12. The apparatus as set forth in claim 11, wherein said moving means comprises a switch, a rolling bar, a rolling ball or a rolling wheel.

13. The apparatus as set forth in claim 11, wherein said moving means ensures that when said fingertip moves said moving means, said palm-site of said distal phalange of said user's finger touches said sensing site of said fingerprint sensor.

14. The apparatus as set forth in claim 11, wherein said moving means is a rolling means, a pushing means, a pulling means, a flipping means or a gliding means.

15. The apparatus as set forth in claim 1, wherein said guiding means comprises a sensor.

16. The apparatus as set forth in claim 15, wherein said sensor comprises a switch, a rolling bar, a rolling ball, a rolling wheel, a fingerprint sensor, an optical sensor or a conductive element.

17. The apparatus as set forth in claim 15, wherein said sensor is associated with a predetermined function, wherein said predetermined function is executed by an execution means once said fingertip of said user's finger activates said sensor.

18. The apparatus as set forth in claim 15, further comprising a verifying means to verify said fingerprint obtained by said fingerprint sensor once said palm-site of said distal phalange of said user's finger touches said sensing site of said fingerprint sensor.

19. The apparatus as set forth in claim 18, wherein said sensor is associated with a predetermined function and wherein said predetermined function is executed by an execution means once said fingerprint is successfully verified by said verifying means and said sensor has been activated.

20. A method for obtaining a fingerprint of a user's finger, comprising the steps of:
(a) providing a fingerprint sensor wherein the sensing site of said fingerprint sensor is capable of receiving the palm-site of the distal phalange of said user's finger; and
(b) providing a guiding means wherein said guiding means comprises a guiding plane wherein said guiding plane makes a relative and obtuse angle with said fingerprint sensor, and wherein said guiding means guides the fingertip of said user's finger toward said guiding means and therewith guiding said palm-site of said distal phalange of said user's finger toward said sensing site of said fingerprint sensor.

21. The apparatus as set forth in claim 20, wherein said relative and obtuse angle is substantially 140 degrees with a standard deviation of substantially +/−20 degrees.

22. The apparatus as set forth in claim 20, wherein said guiding plane is a tangent of a contact point of said fingertip at said guiding means.

23. The apparatus as set forth in claim 22, wherein said relative and obtuse angle is greater than or equal to substantially 90 degrees and less than substantially 180 degrees.

24. The method as set forth in claim 20, wherein said position of said guiding means establishes that when said fingertip of said user's finger touches said guiding means, said palm-site of said distal phalange of said user's finger touches said sensing site of said fingerprint sensor.

25. The method as set forth in claim 20, wherein said guiding means is positioned at the same plane as the plane at which said fingerprint sensor is positioned.

26. The method as set forth in claim 20, wherein said guiding means is positioned at a different plane from the plane at which said fingerprint sensor is positioned.

27. The method as set forth in claim 20, wherein said guiding means is positioned substantially near the bottom area of said fingerprint sensor.

28. The method as set forth in claim 20, wherein said guiding means comprises a contact point or contact area for said fingertip.

29. The method as set forth in claim 20, wherein said guiding means comprises a visual object.

30. The method as set forth in claim 20, wherein said guiding means comprises a moving means.

31. The method as set forth in claim 30, wherein said moving means comprises a switch, a rolling bar, a rolling ball or a rolling wheel.

32. The method as set forth in claim 30, wherein said moving means ensures that when said fingertip moves said moving means, said palm-site of said distal phalange of said user's finger touches said sensing site of said fingerprint sensor.

33. The method as set forth in claim 30, wherein said moving means is a rolling means, a pushing means, a pulling means, a flipping means or a gliding means.

34. The method as set forth in claim 20, wherein said moving means comprises a sensor.

35. The method as set forth in claim 34, wherein said sensor comprises a switch, a rolling bar, a rolling ball, a rolling wheel, a fingerprint sensor, an optical sensor or a conductive element.

36. The method as set forth in claim 34, wherein said sensor is associated with a predetermined function, wherein said predetermined function is executed by an execution means once said fingertip of said user's finger activates said sensor.

37. The method as set forth in claim 34, further comprising the step of providing a verifying means to verify said fingerprint obtained by said fingerprint sensor once said palm-site of said distal phalange of said user's finger touches said sensing site of said fingerprint sensor.

38. The method as set forth in claim 37, wherein said sensor is associated with a predetermined function and wherein said predetermined function is executed by an execution means once said fingerprint is successfully verified by said verifying means and said sensor has been activated.

39. An apparatus for obtaining a fingerprint of a user's finger, comprising:
(a) a first contact area, wherein said first contact area comprises a fingerprint sensor wherein the sensing site of said fingerprint sensor is capable of receiving the palm-site of the distal phalange of said user's finger; and
(b) a second contact area positioned to make a relative and obtuse angle with said first contact area to guide the fingertip of said user's finger toward said second contact area and therewith guiding said palm-site of said distal phalange of said user's finger toward said sensing site of said fingerprint sensor.

40. A method for obtaining a fingerprint of a user's finger, comprising the steps of:
(a) providing a first contact area, wherein said first contact area comprises a fingerprint sensor wherein the sensing site of said fingerprint sensor is capable of receiving the palm-site of the distal phalange of said user's finger; and
(b) providing a second contact area positioned to make a relative and obtuse angle with said first contact area to guide the fingertip of said user's finger toward said second contact area and therewith guiding said palm-site of said distal phalange of said user's finger toward said sensing site of said fingerprint sensor.

41. A system for authenticating a user, comprising:
(a) a fingerprint sensor wherein the sensing site of said fingerprint sensor is capable of receiving the palm-site of the distal phalange of said user's finger;
(b) a guiding means wherein said guiding means comprises a guiding plane wherein said guiding plane makes a relative and obtuse angle with said fingerprint sensor, and wherein said guiding means guides the fingertip of said user's finger toward said guiding means and therewith guiding said palm-site of said distal phalange of said user's finger toward said sensing site of said fingerprint sensor; and
(c) a verifying means to verify said fingerprint from at least a portion of said palm-site of said distal phalange of said user's finger which is obtained once said fingertip touches said guiding means and said palm-site of said distal phalange of said user's finger touches said sensing site of said fingerprint sensor.

42. A method for authenticating a user, comprising the steps of:
(a) providing a fingerprint sensor wherein the sensing site of said fingerprint sensor is capable of receiving the palm-site of the distal phalange of said user's finger;
(b) providing a guiding means wherein said guiding means comprises a guiding plane wherein said guiding plane makes a relative and obtuse angle with said fingerprint sensor, and wherein said guiding means guides the fingertip of said user's finger toward said guiding means and therewith guiding said palm-site of said distal phalange of said user's finger toward said sensing site of said fingerprint sensor; and
(c) providing a verifying means to verify said fingerprint from at least a portion of said palm-site of said distal phalange of said user's finger which is obtained once said fingertip touches said guiding means and said palm-site of said distal phalange of said user's finger touches said sensing site of said fingerprint sensor.

43. A system for executing a function after authenticating a fingerprint of a user, comprising:
(a) a fingerprint sensor wherein the sensing site of said fingerprint sensor is capable of receiving the palm-site of the distal phalange of said user's finger;
(b) a sensor wherein said sensor comprises a guiding plane, wherein said guiding plane makes a relative and obtuse angle with said fingerprint sensor, and wherein said guiding means guides the fingertip of said user's finger toward said guiding means and therewith guiding said palm-site of said distal phalange of said user's finger toward said sensing site of said fingerprint sensor;
(c) a verifying means to verify said fingerprint from at least a portion of said palm-site of said distal phalange of said user's finger which is obtained once said fingertip touches said sensor and said palm-site of said distal phalange of said user's finger touches said sensing site of said fingerprint sensor; and
(d) an execution means to execute said function once said fingerprint is successfully verified by said verifying means.

44. A method for executing a function after authenticating a fingerprint of a user, comprising the steps of:
(a) providing a fingerprint sensor wherein the sensing site of said fingerprint sensor is capable of receiving the palm-site of the distal phalange of said user's finger;
(b) providing a sensor wherein said sensor comprises a guiding plane, wherein said guiding plane makes a relative and obtuse angle with said fingerprint sensor, and wherein said guiding means guides the fingertip of said user's finger toward said guiding means and therewith guiding said palm-site of said distal phalange of said user's finger toward said sensing site of said fingerprint sensor;
(c) providing a verifying means to verify said fingerprint from at least a portion of said palm-site of said distal phalange of said user's finger which is obtained once said fingertip touches said sensor and said palm-site of said distal phalange of said user's finger touches said sensing site of said fingerprint sensor; and
(d) providing an execution means to execute said function once said fingerprint is successfully verified by said verifying means.
